(19) United States
(12) Patent Application Publication
(10) Pub. No.: US 2018/0028900 A1
(43) Pub. Date: Feb. 1, 2018

(54) Duel card game method of play

(71) Applicant: MICHAEL MONTECILLO, HAMMONTON, NJ (US)

(72) Inventor: MICHAEL MONTECILLO, HAMMONTON, NJ (US)

(21) Appl. No.: 15/330,052

(22) Filed: Jul. 30, 2016

(51) Int. Cl. A63F 1/00; A63F 13/80; A63F 13/92

(52) U.S. Cl. CPC A63F 1/00; A63F 13/92; A63F 13/80; A63F 2001/008; A63F 2300/204

(57) ABSTRACT

The present invention is a method of a duel card game. The game is not limited to a hand-held card, but it can also be in another form of media such as phone application, computer, or video games. Each player has his or her own equal number of cards. Each card has its own character. Each character has six categories. Each of the categories have three sub categories. The cards are evenly distributed to the players. A calling player starts the game. He or she will choose a number of categories for duel. The sub categories or the elements will decide who will win the duel game. The player who wins the most, on the called categories takes the opponent's card and put it to his or her side. The calling player can also use a spell on the card. In the end the person who gets the most cards, or has the most number of points wins the card game.

### CROSS REFERENCE TO RELATED APPLICATION

Not Applicable

### STATEMENT REGARDING FEDERALLY SPONSORSHIP

Not Applicable

### MIROFICHE APPENDIX

Not Applicable

### BACKGROUND OF THE INVENTION

### 1) Field of the Invention

This present invention is in the technical field that relates to a method of play for a card game. More specifically a duel card game.

### 2) Description of the Related Art

There are a lot of methods in playing a card game. Some are simple and some are more technical. One method is the duel battle card game where in two opponents try to win by strategy, logic, and sometimes just luck of the card. One method of this card game was created by Richard Channing Garfield, U.S. Pat. No. 5,662,332A, of Wizard of the Coast Inc. with a publication date of Sep. 2, 1992. Here the cards have several features: the players can win by points, manna, attack cards, and spell cards. However, this method of card game requires the player to be more mature to know the rules of the game. The inventor even put it in the box that the game was for 13 years old and up. For younger children this kind of game is too complicated. Another method of the card game is poker, where in the cards or group of card's arrangement has a value. The person who arranges his or her card to the highest value wins the game. This method of a card game can take minutes to an hour in order to finish a single game, and as mentioned before, the players need to be old enough to understand the arrangements of cards. This game is not suitable for children under 6 years old.

Another related art that has been played by children for years is the game: “Rock, Paper, and Scissor” patented by Robert Simmons Jr. U.S. Pat. No. 6,843,477B2, publication date Jan. 18, 2005. Rock wins over scissors, scissors wins over paper and paper wins over rock. This is a simple game that can only last a few minutes. The winner can be decided quickly as compared to the other card games that require a lot more time to finish a game. This method of the game is quick, easy, and even 6 years old can play this game.

### SUMMARY OF THE INVENTION

In accordance with the present embodiment of a duel card game, two or more players will try to win the other player's card by scoring more points than the other in a called category. To start, each player is given an equal amount of cards. A starter set contains 18 cards with 18 characters. Players can combine other sets or have a set of their own. There is no fixed number of playing cards in a game as long as an even number of cards is distributed to each player. Each card has one character that has six categories and each category is further divided into 3 sub categories also known as elements. Each player will choose one card from his or her own deck for the duel. The starting player, also known as the calling player is the one who chooses a category for the duel. He or she will choose a number of categories. Keep in mind that a minimum of two and in any order from the six categories may be chosen. The six categories are: CHARACTER, BEING, WORLD, ELEMENT, ETHOS and GIFT.

Aside from the six categories, the calling player can also use a spell on his or her card. Some cards have a spell and some cards don't. If the calling player wants to use the spell, he or she will say “I want to use a spell”, and then choose a number of categories from the six categories for the duel. Spells can alter the result of the duel. The player that wins the most categories wins the round and takes the opponents losing card. The winning player sets this card to his or her side.

If there is a tie where in both players win equally, both players can decide, if they want to keep the card and use it again in another duel or break the tie in a standoff. To break the tie, the players put the two tied cards down; then the next player will chose the next categories. The player who wins the next duel wins the tied cards. All in all, the winner of the tie will have 4 cards to set aside. Then another player will be the next calling player.

The cycle continues until all the cards are used. If a player still has a remaining card for the duel, he or she can use the card he or she won from the previous duel. The players who got the most points or the most number of cards wins the duel card game.

### BRIEF DESCRIPTION OF THE DRAWINGS

FIG. 1 is the perspective view of one of the cards in accordance with the embodiment of the invention.

FIG. 2 is the expanded view of the Being category showing the three sub categories or elements. The two elements are shown, but it is on a different card in accordance with the embodiment of the invention.

FIG. 3 is the expanded view of the Element category showing the three sub categories or elements. The two elements are shown, but it is on a different card in accordance with the embodiment of the invention.

FIG. 4 is the expanded view of the Ethos category showing the three sub categories or elements. The two elements are shown, but it is on a different card in accordance with the embodiment of the invention.

FIG. 5 is the expanded view of the World category showing the three sub categories or elements. The two elements are shown, but it is on a different card in accordance with the embodiment of the invention.

FIG. 6 is the expanded view of the Gift category showing the three sub categories or elements. The two elements are shown, but it is on a different card in accordance with the embodiment of the invention.

FIG. 7 is the expanded view of the spells, showing the six spells on a different card in accordance with the embodiment of the invention.

REFFERENCE NUMERAL IN THE DRAWINGS

| | | | |
|---|---|---|---|
| 10 | kind of character | 11 | drawing of the character |
| 12 | name of the character | 13 | points of the character |
| 20 | Being category | 21 | guardian |
| 22 | legend | 23 | spell caster |
| 30 | Element category | 31 | water |
| 32 | fire | 33 | Earth |
| 40 | Ethos category | 41 | courage |
| 42 | fear | 43 | resilience |
| 50 | World category | 51 | Adventure World |
| 52 | Magical World | 53 | Underworld |
| 60 | Gift category | 61 | strength |
| 62 | magic | 63 | knowledge |
| 70 | Spells | 71 | anti-spell |
| 72 | swap spell | 73 | protection spell |
| 74 | reverse spell | 75 | standoff spell |
| 76 | healing spell | | |
| 80, 81, 82 | shapes representing the | | |
| | character | | |
| 83, 84, 85 | shapes representing being | | |
| 86, 87, 88 | shapes representing element | | |
| 89, 90, 91 | shapes representing ethos | | |
| 92, 93, 94 | shapes representing world | | |
| 95, 96, 97 | shapes representing gift | | |

### DETAILED DESCRIPTION OF THE INVENTION

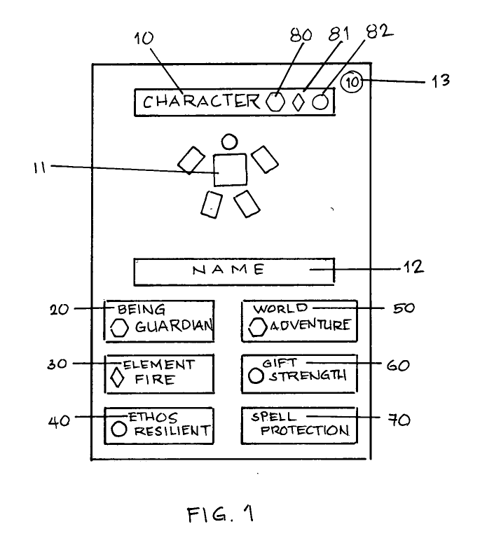

One embodiment of the present invention is a method of playing a duel card game. Referring to FIG. 1 is the overall picture of one of the character in the present invention of the duel card game. 10 is the character of the present invention, 11 is the illustration of the character, 12 is the name of the character, and 13 is the number of points of the character. To start the game, the cards are distributed evenly to all the players. There are no fixed number of cards the players can have, as long as, all of them have an equal number of cards to begin. After the cards are evenly distributed, the player who is the youngest, or oldest, or the player who received the first card starts the duel card game. All the players will take turns and have a chance to be the calling player. The starting player, also known as the calling player, will call out a minimum of two from the six categories. Referring to FIG. 1 Character 10, Being 20, Element 30, Ethos 40, World 50 and Gift 60. The other players will chose a character from his or her deck of cards for the duel and they will also place their chosen card in front of their own deck card. After all the players had chosen a card, all the players will say “1, 2, 3, draw”, and all the players will simultaneously reveal their cards.

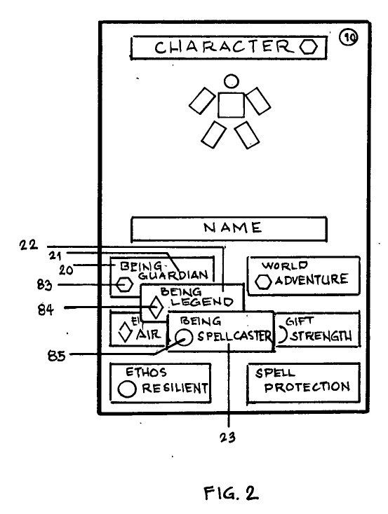

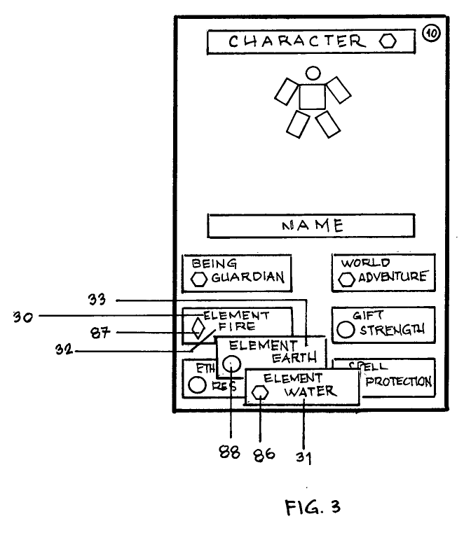

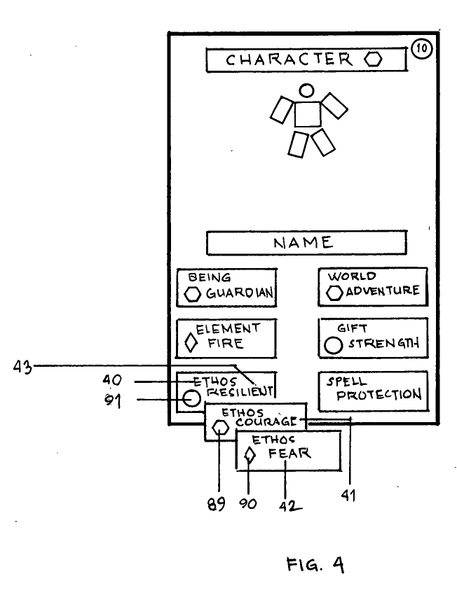

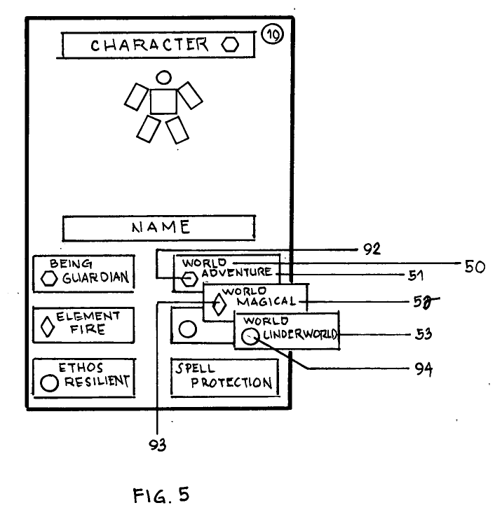

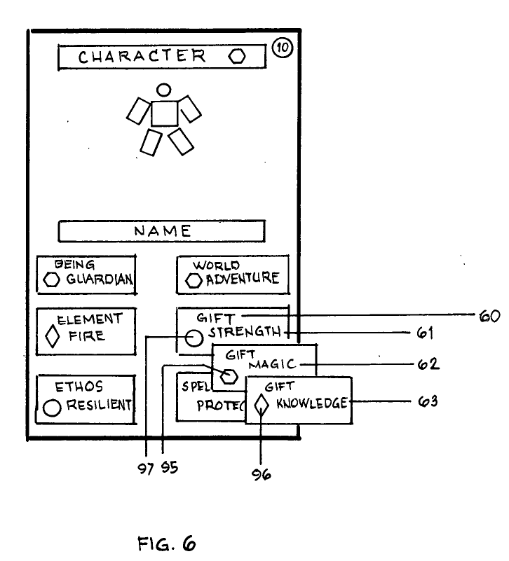

The winner of a category will be decided by referring to the elements.
a) If the player calls “Character” referring to FIG. 1. The characters are also designated with a shape. A hexagon 80 will win over diamond 81. A diamond 81 will win over circle 82. A circle 82 will win over hexagon 80.
b) If the player calls “Being” referring to FIG. 2. There are 3 elements in Being: Guardian 21, Legend 22 and Spell Caster 23. Guardians will win over legends, legends will win over spell caster and spell caster will win over guardians. The elements are also designated with shapes ref. 83, 84, 85: Guardians are represented by a hexagon 83, legends are represented by a diamond 84 and spell casters are represented by a circle 85. A hexagon will win over diamond. A diamond will win over circle. A circle will win over hexagon.
c) If the player calls “Element” referring to FIG. 3. There are 3 elements in “Element”: Water 31, Fire 32 and Earth 33: Water will win over fire, fire will win over earth, and earth will win over water. The elements are also designated with shapes ref. 86, 87 and 88. Water is represented by a hexagon 86, fire is represented by a diamond 87 and earth is represented by a circle 88. A hexagon will win over diamond. A diamond will win over circle. A circle will win over hexagon.
d) If the player calls “Ethos” referring to FIG. 4. There are 3 elements in Ethos: courage 41, fear 42 and resilience 43. Courage will win over fear, fear will win over resilience and resilience will win over courage. The elements are also designated with shapes ref. 89, 90, 91. Courage is represented by a hexagon 89, fear is represented by diamond 90 and resilience is represented by a circle 91. A hexagon will win over diamond. A diamond will win over circle. A circle will win over hexagon.
e) If the player calls “World” referring to FIG. 5. There are 3 elements in World: Adventure World 51, Magical World 52, and Underworld 53. Adventure World will win over Magical World, Magical World will win over Underworld and Underworld will win over Adventure World. The elements are also designated with shapes ref. 92, 93 and 94. Adventure World is represented by a hexagon 92, Magical World is represented by a diamond 93, and Underworld is represented by a circle 94. A hexagon will win over diamond. A diamond will win over circle. A circle will win over hexagon.
f) If the player calls “Gift” referring to FIG. 6. There are 3 elements in Gift: strength 61, magic 62 and knowledge 63. Strength will win over magic, magic will win over knowledge, and knowledge will win over strength. The elements are also designated with shapes ref. 95, 96, and 97. Magic is represented by a hexagon 95, knowledge is represented by a diamond 96, and strength is represented by a circle 97. A hexagon will win over diamond. A diamond will win over circle. A circle will win over hexagon

The player who wins the most categories in the duel will take the opponent's card and set it to his or her side. If there is a tie the players can decide if they want to play for the tie card or “keep” the card and use it again for another duel. If the players decide to duel for the tie cards, a standoff game will be played for them. Both cards will be put down and another duel round is played against the same player. The player that wins next duel gets the standoff cards and the opponent's battle card. The winner of the tie breaker gets 4 cards to set aside.

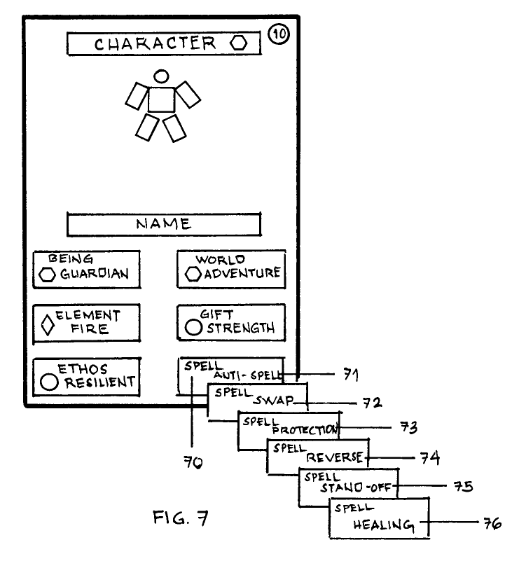

The calling player can also use a spell on the card referring to FIG. 7.

In FIG. 7 the spells are: anti-spell 71, swap spell 72, protection spell 73, reverse spell 74, standoff spell 75, and healing spell 76. The spell has no points but it can alter the results of the duel. Some cards do not have any spell.
Item 71 Anti-spell—cancels the spell that the opposing player uses.
Item 72 Swap spell—the players exchange cards before the battle begins.
Item 73 Protection spell—protects one category of the calling player's choice.
Item 74 Reverse spell—reverses the results of the duel.
Item 75 Standoff spell—makes all the cards equal. Need a tie breaker duel to determine the winner.
Item 76 Healing Spell—the player who wins the duel “heals” one card. He or she get one card from the opponent's previously won cards and can use it for another duel.

How do players use the spell? If the calling player wants to use a spell he or she will first say “I am going to use a spell or a similar term. Then he or she will proceed to choose the number of categories and the players start the duel. At the end of the duel, the players will consider the spell. Here are some examples:

If the calling player uses a protection spell, he or she must first say which category he or she is protecting. By protecting that category he or she already scored one point in one category. Provided the other player has an anti-spell. If He or she wins the most categories that player wins the duel.

If the calling player uses a reverse spell and the other player does not have an anti-spell or another reverse spell, the results of the duel will reverse. If a player wins the duel, the reverse spell will reverse the result, so that player loses the duel. Vice versa, if the player loses the duel, the reverse spell will reverse the result, and that player is actually the winner and takes the opponents losing card.

If the calling player uses the standoff spell, provided the other player does not have an anti-spell, the standoff spell will make all of the cards equal, so both players will put down their cards. The next duel is a tie breaker duel and will decide who will keep all the standoff cards.

If the calling player uses a healing card, provided the other player does not use an anti-spell, the winner of the duel will get one card from his opponent's previously won cards.

If there's a player who still has a card for a duel and the other player does not, the player who does not have a card can use a card from his or her previously won cards. After all the cards are used in the duel, there are two ways of winning: the player who has more cards, wins the game or the player who has the most points. The criteria of the winner by number of cards or by points should be decided before the players starts the duel card game.

PATENT CITATIONS

| Citing Patent | Filing date | Publication Date | Applicant | Title |
|---|---|---|---|---|
| US20060163814A1 | Jul. 9, 2003 | Jul. 27, 2005 | Douglas, Frydi | Card Game |
| U.S. Pat. No. 6,843,477B2 | Aug. 1, 2003 | Jan. 18, 2005 | Robert E. | Rock, Paper, |
| | | | Simmons Jr. | Scissor Card Game |
| U.S. Pat. No. 6,598,880B2 | Dec. 4, 2001 | Jul. 29, 2003 | Daniel F. | Card Game Deck |
| | | | Addabbo | & Method of Play |
| US20040090007A1 | Aug. 1, 2003 | May 18, 2004 | Robert E. | Rock, Paper, Scissor |
| | | | Simmons Jr. | Card Game and |
| | | | | Method of play |
| U.S. Pat. No. 5,662,332A | Oct. 17, 1995 | Sep. 2, 1997 | Richard | Trading Card |
| | | | Garfield | Game Method of |
| | | | | Play |
| U.S. Pat. No. 7,469,901B1 | Sep. 22, 2003 | Dec. 30, 2008 | Michael Hillard | Battle Play Card |
| | | | | Game |

PATENT REFERENCE BY

| Citing Patent | Filing date | Publication Date | Applicant | Title |
|---|---|---|---|---|
| U.S. Pat. No. 4,979,750 | Jan. 16, 1990 | Dec. 25, 1990 | Eugene Endrody | Trading Prop. |
| | | | | Card Game |
| | | | | w/Grouping |
| | | | | Values Score |
| | | | | Card |
| U.S. Pat. No. 5,520,985 | Mar. 3, 1995 | May 28, 1996 | Helicher, Leonard | Collectible Card |
| | | | | Assembly |
| U.S. Pat. No. 4,243,226 | Mar. 12, 1979 | Jan. 6, 1981 | Kendall Roy, E. | Card Game |
| U.S. Pat. No. 6,554,702 | Apr. 5, 2001 | Apr. 29, 2003 | Shaun Manar | Card Game and |
| | | | | Method thereof |
| | | | | For playing real |
| | | | | Time Card Game |
| US20030067117 | Sep. 25, 2002 | Apr. 10, 2003 | Hardie Jeannie | Card Game |
| | | | Burns | |
| US20060232011 | Apr. 16, 2005 | Oct. 19, 2006 | Upper Deck | Trading Card |
| | | | Company | Game |
| U.S. Pat. No. 6,508,706 | Jan. 21, 2001 | Jan. 21, 2003 | David Howard | Electronics |
| | | | Sitrick | Interactive |
| | | | | Gaming app. |
| | | | | System and |
| | | | | Methodology |
| U.S. Pat. No. 7,427,068B2 | Dec. 1, 2006 | Sep. 23, 2008 | Richard G. | Transcendental |
| | | | Middleton | Element Card |
| | | | | Game Using |
| | | | | Dice |
| U.S. Pat. No. 5,887,873A | Aug. 21, 1997 | Mar. 30, 1999 | Jon Freeman | Unique Deck of |
| | | | | Playing Cards |
| US20020101037 | Dec. 4, 2001 | Aug. 1, 2002 | Daniel Addabbo | Card Game |
| | | | | Deck and |
| | | | | Method of |
| | | | | Play |
| U.S. Pat. No. 5,213,334 | Feb. 27, 1992 | May 25, 1993 | YIH Leef | Deck of Cards |
| | | | | Having Set of |
| | | | | six Card and |
| | | | | Specialty Card |
| U.S. Pat. No. 7,144,013B2 | Aug. 21, 2003 | Dec. 10, 2006 | Tokio Tanaka | Card Game |
| U.S. Pat. No. 5,951,013 | Mar. 12, 1998 | Sep. 14, 1999 | Campanella, | Card Battle Game |
| | | | Christopher | |
| U.S. Pat. No. 85/288,288B2 | Apr. 26, 2012 | Sep. 10, 2013 | Howard | Collectible Gift |
| | | | Fleischer | Card |
| U.S. Pat. No. 62/540,099B1 | May 5, 1999 | Jul. 3, 2001 | Mark Pederson | Playing Card War |
| | | | | Game |
| US2004004849A2 | Jul. 9, 2003 | Jul. 15, 2004 | Douglas Frisoli | Card Game |

1) A method of playing a duel card game for two or more players where in each player will have an equal numbers of cards for the duel. A starter set of the said card game contains 18 cards. Each card has the plurality of different characters. The said characters can be illustrated by drawings, pictures, computer graphics and symbols. To start the said game, a starting player, also known as the calling player, will chose a number of categories for each duel. Each player will choose one character from his or her own deck of cards and use the said card for the said duel. After the players choose their character for the duel, they will put it in front of their own deck. After putting the card in front of their own deck, all the players will count “1, 2, 3 draw” and then all the players will reveal their card at the same time.

2) A method of the said duel card game as claimed in 1, where in the winner of the said category will be determined by a triangular loop system of the sub-categories. The sub categories have its elements and shapes. The first element and shape will win over the second element and shape, but will lose to the third element and shape. The said second element and shape will win over the said third element and shape, but will lose to the said first element and shape. The said third element and shape will win over the said first element and shape, but will lose to the said second element and shape.
If there is a tie, the players can chose to keep their card and use it again for another duel, or put the card down and play a tie breaker. To break the tie, whoever wins the next duel wins the tie break. The winning player will take the 4 cards: the two tie cards, the opponent current card and his or her card. All the cards are set aside.

3) A method of the said duel card game as claimed in 1 where the calling player can use a spell on the card. The spell can alter the winner of the said duel.

4) A method of the said duel card game where in the player can exchange a character from the card he or she previously won in the duel card game. If there is still unused card for a duel, the player who does not have a card can choose a card from his or her previously won deck and use it for the duel.

5) A method of winning the said duel card game. The players who has the most points or the most number of cards win the card game.

6) A method of playing the said card duel game in another form of media. It can be also be in phone application, video or computer form. In phone apps, video, and computer form, the same method of rules applies.
